(19) United States
(12) Patent Application Publication
(10) Pub. No.: US 2024/0002052 A1
(43) Pub. Date: Jan. 4, 2024

(54) SPREADING SYSTEM, PLANT PROTECTION UNMANNED AERIAL VEHICLE, AND SPREADING CONTROL METHOD

(71) Applicant: SZ DJI TECHNOLOGY CO., LTD., Shenzhen (CN)

(72) Inventors: Zhuang FENG, Shenzhen (CN); Ruiqiang ZHANG, Shenzhen (CN)

(73) Assignee: SZ DJI TECHNOLOGY CO., LTD., Shenzhen (CN)

(21) Appl. No.: 18/369,169

(22) Filed: Sep. 16, 2023

Related U.S. Application Data
(63) Continuation of application No. PCT/CN2021/081180, filed on Mar. 16, 2021.

(51) Int. Cl. B64D 1/16; A01C 17/00; B64U 10/13

(52) U.S. Cl. CPC B64D 1/16; A01C 17/003; B64U 10/13; B64U 2101/45

(57) ABSTRACT

A spreading system for a plant protection UAV is provided, including a material inlet, a material conveying mechanism, and a material spreading mechanism. The material inlet is configured to dock with the material box. The material conveying mechanism includes a screw mechanism and a driving device connected to the screw mechanism. The material spreading mechanism is used to spread a material in the material box. The driving device may drive the screw mechanism to rotate, so as to transfer the material from the material inlet to the material spreading mechanism, thereby quantitatively feeding the material spreading mechanism and improving the spreading uniformity of the plant protection UAV. A plant protection UAV and a spreading control method are also provided.

### RELATED APPLICATIONS

This application is a continuation application of PCT application No. PCT/CN2021/081180, filed on Mar. 16, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of agricultural equipment, in particular to a spreading system, a plant protection unmanned aerial vehicle (UAV), and a spreading control method.

### BACKGROUND

In recent years, agricultural modernization and precision agriculture have continued to move forward. The development of agricultural machinery has provided great convenience for agricultural modernization. By carrying a spreading system on a UAV to realize the spreading of granular and powdery materials, such as in rice seeding, fertilization and other scenarios, an efficient and convenient operation method is provided for agricultural modernization. However, for the traditional UAV spreading system, when spreading granular or powder materials, the feeding method of material particles from a storage box to a spreading disc relies on the gravity falling method. With this feeding method, the controllable range of the flow of material particles is quite low, and it is difficult to accurately control the discharge flow of material particles.

### SUMMARY

The present disclosure provides a spreading system, a plant protection UAV, and a spreading control method, in order to quantitatively feed a material spreading mechanism, and improve the spreading uniformity of the plant protection UAV.

In a first aspect, the present disclosure provides a spreading system for an aerial vehicle, including: at least one material inlet, configured to dock with a material box; a material conveying mechanism, including at least one screw mechanism and at least one driving device in transmission connection with the at least one screw mechanism; and at least one material spreading mechanism, configured to spread a material in the material box, where the at least one driving device is configured to drive the at least one screw mechanism to rotate, so as to transfer the material from the at least one material inlet to the at least one material spreading mechanism in a rotating manner, the at least one material spreading mechanism includes a spinning disc, and when the spinning disc rotates, the material in the spinning disc is thrown out along a periphery of the spinning disc, and when the at least one material spreading mechanism is connected to a frame of the aerial vehicle, an angle between a rotation plane of the spinning disc and a yaw axis of the aerial vehicle is equal to 0°.

In a second aspect, the present disclosure provides a spreading system for an aerial vehicle, including: at least one material inlet, configured to dock with a material box; a material conveying mechanism, including at least one screw mechanism and at least one driving device in transmission connection with the at least one screw mechanism; and at least one material spreading mechanism, configured to spread a material in the material box, where the at least one driving device is configured to drive the at least one screw mechanism to rotate, so as to transfer the material from the at least one material inlet to the at least one material spreading mechanism in a rotating manner; and the at least one screw mechanism includes a first screw mechanism and a second screw mechanism, and the first screw mechanism and the second screw mechanism are arranged non-coaxially and driven by the same driving device simultaneously.

Embodiments of the present disclosure provides a spreading system, a plant protection UAV, and a spreading control method, in order to quantitatively feed a material spreading mechanism, and improve the spreading uniformity of the plant protection UAV.

It should be understood that the above general description and the following detailed description are only exemplary and explanatory, and do not limit the scope of the embodiments of the present disclosure.

### BRIEF DESCRIPTION OF THE DRAWINGS

In order to more clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a schematic diagram of the structure of a spreading system according to some exemplary embodiments of the present disclosure;

FIG. 2 is a schematic diagram of an application scenario of a plant protection UAV according to some exemplary embodiments of the present disclosure;

FIG. 3 is a schematic diagram of the structure of a spreading system according to some exemplary embodiments of the present disclosure;

FIG. 4 is a schematic diagram of the structure of a protection UAV according to some exemplary embodiments of the present disclosure;

FIG. 5 is a schematic diagram of the structure of a protection UAV according to some exemplary embodiments of the present disclosure;

FIG. 6 is a schematic diagram of the structure of a protection UAV according to some exemplary embodiments of the present disclosure;

FIG. 7 is a schematic diagram of the structure of a protection UAV according to some exemplary embodiments of the present disclosure;

FIG. 8 is a schematic diagram of the structure of a protection UAV according to some exemplary embodiments of the present disclosure; and

FIG. 9 is a schematic flow chart of a spreading control method of a plant protection UAV according to some exemplary embodiments of the present disclosure.

### DESCRIPTION OF ELEMENT SYMBOLS IN THE DRAWINGS

1000. plant protection UAV;
100. spreading system;
10. material inlet;
11. first material inlet;
12. second material inlet;
20. material conveying mechanism;
21. screw mechanism;
211. first screw mechanism;
212. second screw mechanism;
22. driving device;
30. material spreading mechanism;
31. spinning disc;
32. spreading port;
40. material box;
51. first material outlet;
52. second material outlet;
200, frame;
201, body;
202, landing gear;
300, power system.

### DETAILED DESCRIPTION

The technical solutions in some exemplary embodiments of the present disclosure will be described below in conjunction with the drawings. Apparently, the described embodiments are some exemplary embodiments of the present disclosure, but not all of them. Based on the examples disclosed herein, all other embodiments obtained by a person of ordinary skill in the art without creative efforts should fall within the scope of protection of the present disclosure.

In the description of the present disclosure, it should be understood that the orientations or positional relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc. are based on the orientations or positional relationship shown in the drawings. They are used only for the convenience of describing the present application and simplifying the description, rather than indicating or implying that the device or element referred to must have a specific orientation, be constructed and operated in a specific orientation, etc. Therefore, it should not be construed as limiting the present disclosure. In addition, the terms “first” and “second” are used for descriptive purposes only, and cannot be interpreted as indicating or implying relative importance or implicitly specifying the quantity of indicated technical features. Thus, a feature defined as “first” or “second” may explicitly or implicitly includes one or more of the features. In the description of the present disclosure, “a plurality of” means two or more, unless otherwise specifically defined.

It should also be understood that the terminology used in the present disclosure is for the purpose of describing specific exemplary embodiments only and is not intended to limit the present disclosure. As used in the present disclosure and the appended claims, the singular forms “a”, “an” and “the” are intended to include plural referents unless the context clearly dictates otherwise.

It should be further understood that the term “and/or” used in the present disclosure and appended claims refers to any combination of one or more of the associated listed items and all possible combinations, and includes these combinations.

The inventors of the present disclosure found when the traditional UAV spreading system is used for spreading granular or powder materials, the feeding method of material particles transported from a storage box to a spreading disc relies on a gravity falling method or a roller quantitative feeding method.

For the gravity falling method, it is greatly affected by the materials (such as viscous materials). The controllable range and controllable precision of the flow of material particles are quite low. Thus, it is difficult to accurately control the falling flow of material particles, and the uniformity of spreading is not desirable.

For the roller quantitative feeding method, the spreading process is discontinuous, and the spreading density is uneven when the flying speed of the drone is constant.

Therefore, the inventors of the present disclosure provide a spreading system, a plant protection UAV and a spreading control method, so as to realize quantitative feeding to the material spreading mechanism and improve the spreading uniformity of the plant protection UAV.

Some exemplary embodiments of the present disclosure will be described in detail below with reference to the accompanying drawings. In the case of no conflict, the following exemplary embodiments and features in these embodiments may be combined with one another.

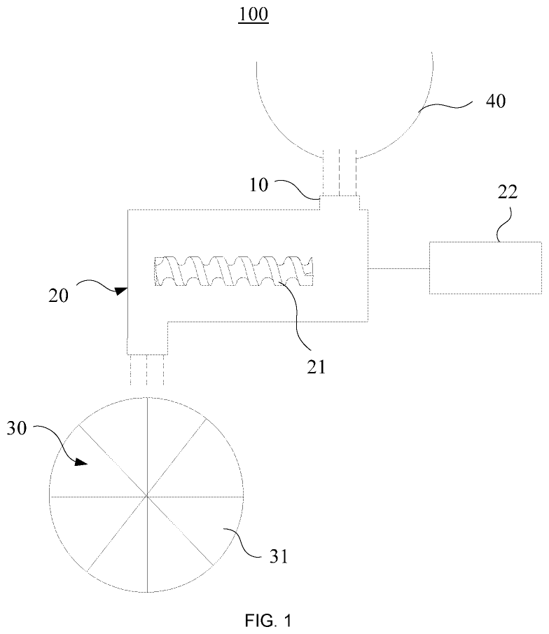

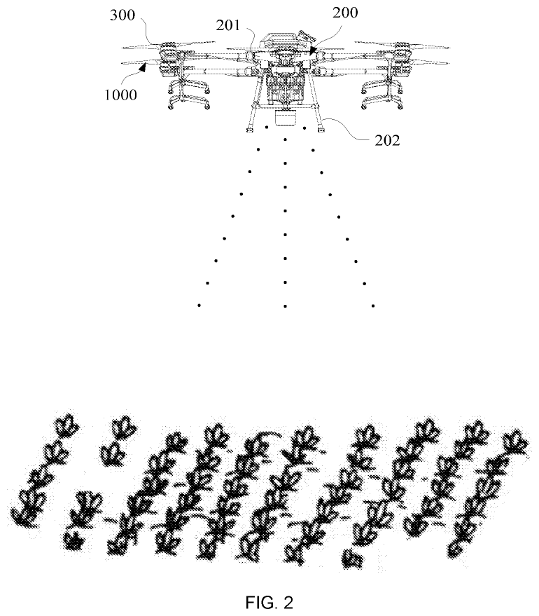

With reference to FIG. 1, a spreading system 100 provided by exemplary embodiments of the present disclosure is shown, which may be used for a plant protection UAV 1000 (see FIG. 2).

With reference to FIG. 2, the structure of the plant protection UAV 1000 provided by exemplary embodiments of the present disclosure is shown.

Exemplarily, the plant protection UAV 1000 may be a rotary-wing unmanned aerial vehicle, a fixed-wing unmanned aerial vehicle, an unmanned helicopter, or a mixed fixed-wing rotary-wing unmanned aerial vehicle, etc. The rotor UAV may be a single-rotor UAV or a multi-rotor UAV. The Multi-rotor UAV may include a dual-rotor aircraft, a three-rotor aircraft, a four-rotor aircraft, a six-rotor aircraft, an eight-rotor aircraft, a ten-rotor aircraft, or a twelve-rotor aircraft.

With reference to FIG. 2, the plant protection UAV 1000 may include a frame 200 and a power system 300. The frame 200 may include a body 201 and a landing gear 202. The body 201 may include a center frame and one or more arms connected to the center frame, and the one or more arms extend radially from the center frame. The landing gear 202 is connected to the body 201 and is used for supporting the plant protection UAV 1000 when it lands.

The spreading system 100 may be mounted on the frame 200 of the plant protection UAV 1000. During the flight of the plant protection UAV 1000, the power system 300 may drive the frame 200 to move, rotate, turn over, etc., thereby driving the spreading system 100 to move to different positions or different angles, so as to perform spreading operations in a preset area.

Exemplarily, the materials spread by the spreading system 100 may include solid materials, such as at least one of solid fertilizers, solid feeds, pollens, seeds, solid pesticides and the like.

The power system 300 may include one or more propellers (not shown) and one or more power motors (not shown) corresponding to the one or more propellers. The power motors and the propellers may be arranged on the arms of the plant protection UAV 1000. The power motors may be used to drive the propeller to rotate, so as to provide power for the plant protection UAV 1000 to fly. This power enables the plant protection UAV 1000 to move in one or more degrees of freedom. In some exemplary embodiments, the plant protection UAV 1000 may rotate about one or more axes of rotation. For example, the above-mentioned rotation axes may include a roll axis, a yaw axis and a pitch axis. It should be understood that the power motor may be a DC motor or a permanent magnet synchronous motor. Alternatively, the power motor may be a brushless motor or a brushed motor.

In some exemplary embodiments, with reference to FIG. 1, the spreading system 100 may include a material inlet 10, a material conveying mechanism 20 and a material spreading mechanism 30. The material inlet 10 is configured to dock with a material box 40. The material conveying mechanism 20 includes a screw mechanism 21 and a driving device 22 that is in transmission connection with the screw mechanism 21. The material spreading mechanism 30 is used for spreading a material in the material box 40. The driving device 22 may drive the screw mechanism 21 to rotate, and the screw mechanism 21 transfers the material from the material inlet 10 to the material spreading mechanism 30 by rotating.

In the spreading system 100 in some exemplary embodiments, the screw mechanism 21 may transfer the material from the material inlet 10 to the material spreading mechanism 30 by rotating. Therefore, the motion information of the screw mechanism 21 may be controlled by the driving device 22, so as to realize the precise control of the feeding flow of the material. It has a high controllable range, is less affected by the shape of the material, and can realize continuous feeding, thereby realizing quantitative feeding to the material spreading mechanism 30. Thus, the spreading uniformity of the plant protection UAV 1000 has been improved.

It can be understood that the motion information of the screw mechanism 21 includes the motion speed and/or the motion direction of the screw mechanism 21. The driving parameters of the driving device 22 include the rotational speed and/or the rotation direction of the driving device 22.

It can be understood that when the rotation speed of the screw mechanism 21 is high, the feeding flow of the material transferred from the material inlet 10 to the material spreading mechanism 30 is relatively high. When the rotation speed of the screw mechanism 21 is low, the feeding flow of the material transferred from the material inlet 10 to the material spreading mechanism 30 is relatively low. Therefore, the purpose of quantitative spreading can be achieved by controlling the rotation speed of the screw mechanism 21 by the driving device 22.

In some exemplary embodiments, the screw mechanism 21 includes at least one of the following elements: a worm, a spiral brush, and the like.

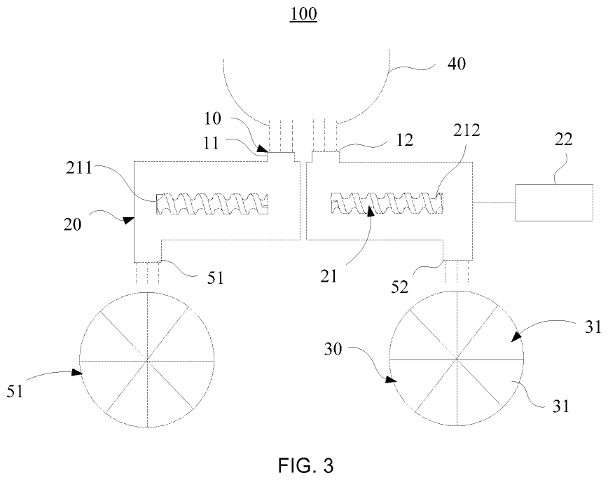

Referring to FIGS. 1 and 3, in some exemplary embodiments, the number of the screw mechanisms 21 is designed corresponding to the number of the material spreading mechanisms 30. For example, one screw mechanism 21 is correspondingly provided with one or more material spreading mechanisms 30. In another example, one or more material spreading mechanisms 30 are correspondingly provided with a plurality of screw mechanisms 21. Exemplarily, the number of the screw mechanism 21 is set in a one-to-one correspondence with the number of the material spreading mechanism 30.

Referring to FIG. 3, in some exemplary embodiments, the number of the screw mechanism 21 includes at least two. Exemplarily, the driving device 22 may drive at least two screw mechanisms 21 to rotate at different rotation speeds and/or directions. In this way, the plant protection UAV 1000 may spread materials according to actual scene requirements, and the operation flexibility of the plant protection UAV 1000 may be improved.

Referring to FIG. 3, the screw mechanism 21 includes a first screw mechanism 211 and a second screw mechanism 212. The material inlet 10 includes a first material inlet 11 and a second material inlet 12. The spreading system 100 includes a first material outlet 51 and a second material outlet 52 for docking with the material spreading mechanism 30. The first screw mechanism 211 may transfer materials from the first material inlet 11 to the first material outlet 51, and the second screw mechanism 212 may transfer materials from the second material inlet 12 to the second material outlet 52.

The motion information of the first screw mechanism 211 may be controlled by controlling the driving parameters of the driving device 22 corresponding to the first screw mechanism 211, such that the feeding flow of the material from the first material inlet 11 to the material spreading mechanism 30 through the first material outlet 51 may be precisely controlled. The motion information of the second screw mechanism 212 may be controlled by controlling the driving parameters of the driving device 22 corresponding to the second screw mechanism 212, such that the feeding flow of the material from the second material inlet 12 to the material spreading mechanism 30 through the second material outlet 52 may be precisely controlled. Therefore, quantitative feeding to the material spreading mechanism 30 is realized and the spreading uniformity of the plant protection UAV 1000 is improved.

Understandably, the number of driving devices 22 may be designed according to actual requirements, such as one, two, three or more. The driving device 22 corresponding to the first screw mechanism 211 may have the same as the driving device 22 corresponding to the second screw mechanism 212, or there may be two independent driving devices 22.

For example, one driving device 22 may simultaneously drive the first screw mechanism 211 and the second screw mechanism 212 to rotate. The structure is thus simple, and the weight and/or volume of the spreading system 100 can be reduced as much as possible while ensuring the normal operation of the first screw mechanism 211 and the second screw mechanism 212.

In some exemplary embodiments, the driving device 22 includes an electric motor. The motor of the driving device 22 may be a DC motor or a permanent magnet synchronous motor. Alternatively, the motor of the driving device 22 may be a brushless motor or a brushed motor.

Understandably, the material flowing out from the first material outlet 51 and the material flowing out from the second material outlet 52 may flow to the same material spreading mechanism 30 or the same spinning disc 31, or may flow to two different material spreading mechanisms 30 or different spinning discs 31.

Referring to FIG. 3, at least two screw mechanisms 21 are arranged coaxially. For example, the screw mechanism 21 may include a first screw mechanism 211 and a second screw mechanism 212, and the first screw mechanism 211 and the second screw mechanism 212 are arranged coaxially.

In some exemplary embodiments, the at least two screw mechanisms 21 may also be arranged non-coaxially, which is not limited herein. In some exemplary embodiments, the number of the screw mechanism 21 may also include one.

It is understood that the first material inlet 11, the first material outlet 51, the second material inlet 12, and the second material outlet 52 may all be designed in any suitable position according to actual needs.

For example, the first material inlet 11 may be located above or obliquely above one end of the first screw mechanism 211. The first material outlet 51 may be located below or obliquely below another end of the first screw mechanism 211. In this way, the material in the material box 40 may fall to the first material inlet 11 under the action of gravity. The material sent out in a rotating manner through the first screw mechanism 211 may fall to the material spreading mechanism 30 through the first material outlet 51 under the action of gravity, so as to avoid accumulation of material at the first material inlet 11 or the first material outlet 52/Therefore, it is ensured that the material can be quantitatively fed to the material spreading mechanism 30, and the spreading uniformity of the plant protection UAV 1000 is improved. For the relative position of the second material inlet 12 and the second material outlet 52, reference may be made to the relative positions of the first material inlet 11 and the first material outlet 52 in any of the above-mentioned exemplary embodiments. This will not be repeated again.

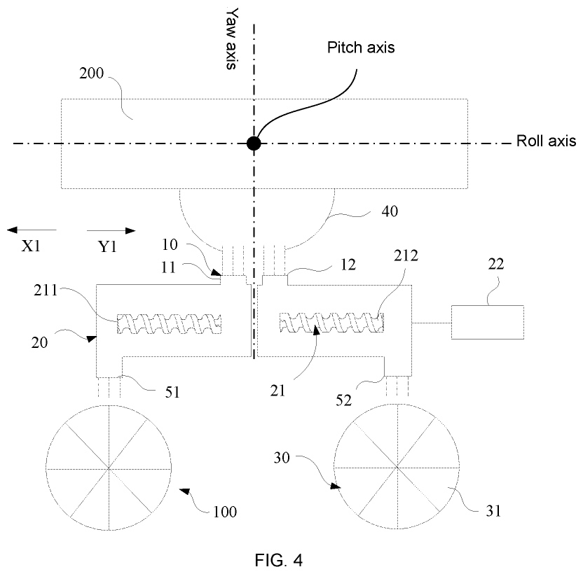

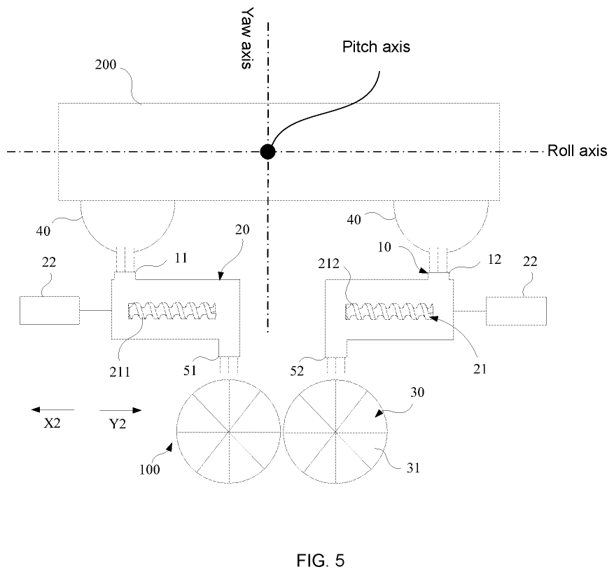

Referring to FIGS. 4 and 5, in some exemplary embodiments, when the spreading system 100 is connected to the frame 200 of the plant protection UAV 1000, the projections of the first material inlet 11 and the first material outlet 51 on a plane perpendicular to a heading axis of the plant protection UAV 1000 may be arranged in sequence in a first direction; the projections of the second material inlet 12 and the second material outlet 52 on a plane perpendicular to the heading axis of the plant protection UAV 1000 may be arranged in sequence along a second direction, where the first direction is opposite to the second direction.

Exemplarily, the projections of the first material inlet 11 and the first material outlet 51 on a preset projection plane may be arranged at intervals along the first direction. The default projection plane is perpendicular to the heading axis of the plant protection UAV 1000.

Exemplarily, the projections of the second material inlet 12 and the second material outlet 52 on the preset projection plane are arranged in sequence in the second direction.

Exemplarily, the first direction is shown as X1 direction in FIG. 4, and the second direction is shown as Y1 direction in FIG. 4.

Exemplarily, the first direction is shown as Y2 direction in FIG. 5, and the second direction is shown as X2 direction in FIG. 5.

Exemplarily, the first direction is parallel to a roll axis as shown in FIG. 4.

Referring to FIGS. 4 and 5, in some exemplary embodiments, the rotation direction of the first screw mechanism 211 is opposite to the rotation direction of the second screw mechanism 212 to ensure that the material flowing in from the first material inlet 11 may be transferred to the first material outlet 51 and to the material spreading mechanism 30 when the first screw mechanism 211 rotates, the material flowing in from the second material inlet 12 may be transferred to the second material outlet 52 and to the material spreading mechanism 30 when the second screw mechanism 212 rotates.

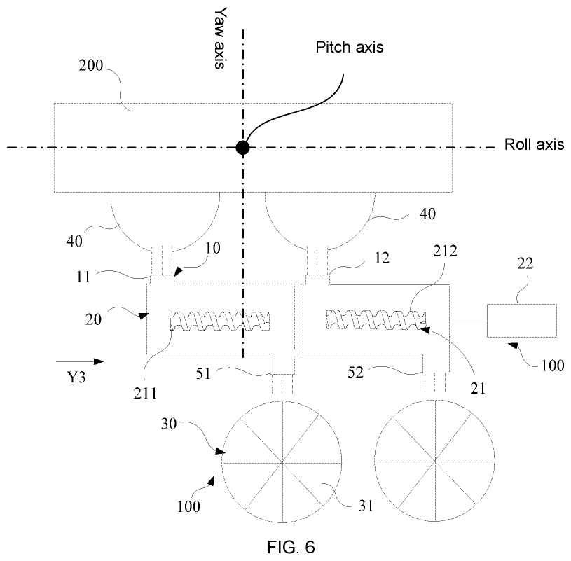

Referring to FIG. 6, in some exemplary embodiments, when the spreading system 100 is connected to the frame 200 of the plant protection UAV 1000, the projections of the first material inlet 11 and the first material outlet 51 on a plane perpendicular to the yaw axis of the plant protection UAV 1000 are arranged in sequence along the first direction; the second material inlet 12 and the second material outlet 52 are arranged in sequence along the first direction.

In some exemplary embodiments, the projections of the first material inlet 11 and the first material outlet 51 on the preset projection plane are spaced apart along the first direction; the projections of the second material inlet 12 and the second material outlet 52 on the preset projection plane are also spaced apart along the first direction. The default projection plane is perpendicular to the yaw axis of the plant protection UAV 1000.

In some exemplary embodiments, the first direction is the Y3 direction in FIG. 6. Of course, in some exemplary embodiments, the first direction may also be opposite to the Y3 direction shown in FIG. 6.

In some exemplary embodiments, the first direction may be parallel to the roll axis in FIG. 6.

Referring to FIG. 6, in some exemplary embodiments, the rotation direction of the first screw mechanism 211 is the same as the rotation direction of the second screw mechanism 212, so as to ensure that the material flowing in from the first material inlet 11 can be transferred to the first material outlet 51 and to the material spreading mechanism 30 when the first screw mechanism 211 rotates, and the material flowing in from the second material inlet 12 can be transferred to the second material outlet 52 and to the material spreading mechanism 30 when the second screw mechanism 212 rotates.

Referring to FIGS. 4 to 6, in some exemplary embodiments, when the spreading system 100 is connected to the frame 200 of the plant protection UAV 1000, the first material outlet 51 and the second material outlet 52 may be arranged in a direction parallel to the roll axis of the plant protection UAV 1000.

For example, the direction parallel to the roll axis of the plant protection UAV 1000 is the X1 direction or the Y1 direction as shown in FIG. 4.

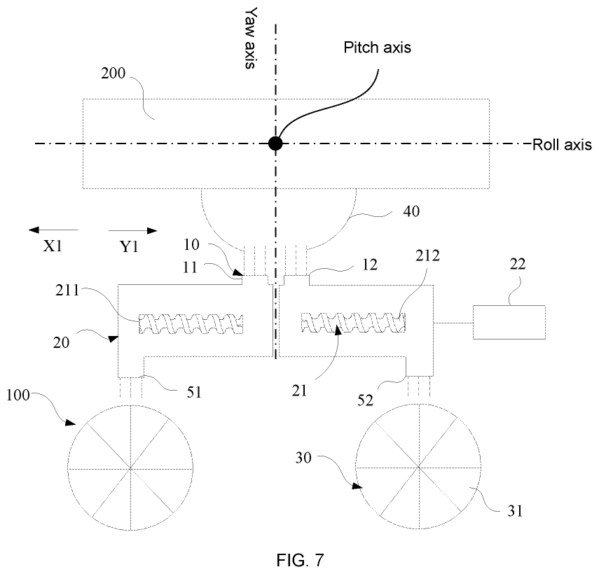

Referring to FIG. 7, in some exemplary embodiments, when the spreading system 100 is connected to the frame 200 of the plant protection UAV 1000, the first material outlet 51 and the second material outlet 52 may be arranged in a direction parallel to the pitch axis of the plant protection UAV 1000.

In some exemplary embodiments, the transmission mode between the driving device 22 and the screw mechanism 21 may include direct transmission or indirect transmission.

For example, the driving device 22 and the screw mechanism 21 are in the direct transmission mode. An output shaft of the driving device 22 may be directly connected to the screw mechanism 21. For example, the output shaft of the driving device 22 is coaxial with the rotation axis of the screw mechanism 21. This structure is simple and can reduce the power consumption of the driving device 22 as much as possible.

For example, the driving device 22 and the screw mechanism 21 are in the indirect transmission mode. The output shaft of the driving device 22 is connected in transmission with the screw mechanism 21 via an intermediate transmission device. That is, the output shaft of the driving device 22 is not directly connected to the screw mechanism 21; the output shaft of the driving device 22 is directly connected to the intermediate transmission device, and the intermediate transmission device is then directly connected to the screw mechanism 21.

For example, the driving device 22 is in transmission connection with the screw mechanism 21 via at least one of a belt transmission structure, a chain transmission structure, a gear transmission structure, a worm gear transmission structure, or a cam transmission structure.

In some exemplary embodiments, in the case where the driving device 22 and the screw mechanism 21 have the indirect transmission. The output shaft of the driving device 22 and the rotation axis of the screw mechanism 21 are non-coaxial and non-parallel. In this way, the size of the spreading system 100 in the direction of the rotation axis of the screw mechanism 21 may be reduced while ensuring that the driving device 22 can drive the screw mechanism 21 to rotate normally. This helps reduce the overall space occupied by the spreading system 100.

For example, the output shaft of the driving device 22 may be substantially perpendicular to the rotation axis of the screw mechanism 21. Of course, in some exemplary embodiments, the output shaft of the driving device 22 may also be non-perpendicular, non-coaxial and non-parallel to the rotation axis of the screw mechanism 21. It can be understood that a first component and a second component are substantially perpendicular to each other within the allowable range of installation or manufacturing errors; the angle between the two may range from 85° to 95°. For example, the first component and the second component are the output shaft of the driving device 22 and the rotation axis of the screw mechanism 21 respectively.

The screw mechanism 21 may be made of any suitable material. For example, the screw mechanism 21 is made of at least one of plastic, metal, colloid, wood material, etc. For example, the screw mechanism 21 may be made of a metal material, which has good strength, stable performance and is not easy to deform.

In some exemplary embodiments, the material spreading mechanism 30 may include a spinning disc spreading mechanism or an air pump spreading mechanism.

Exemplarily, the material spreading mechanism 30 may include at least one blower. The air flow generated by the blower may change the motion trajectory of the material delivered from the material conveying mechanism 20, thereby realizing the spreading operation.

Referring to FIGS. 1 and 3, in some exemplary embodiments, the material spreading mechanism 30 may include a spinning disc 31. The screw mechanism 21 transfers the material from the material inlet 10 to the spinning disc 31 in a rotating manner. When the spinning disc 31 rotates, the material in the spinning disc 31 may be thrown out along the periphery of the spinning disc 31. The spinning disc 31 may generate a centrifugal force when rotating. The material in the spinning disc 31 may be thrown out along the periphery of the spinning disc 31 under the action of the centrifugal force.

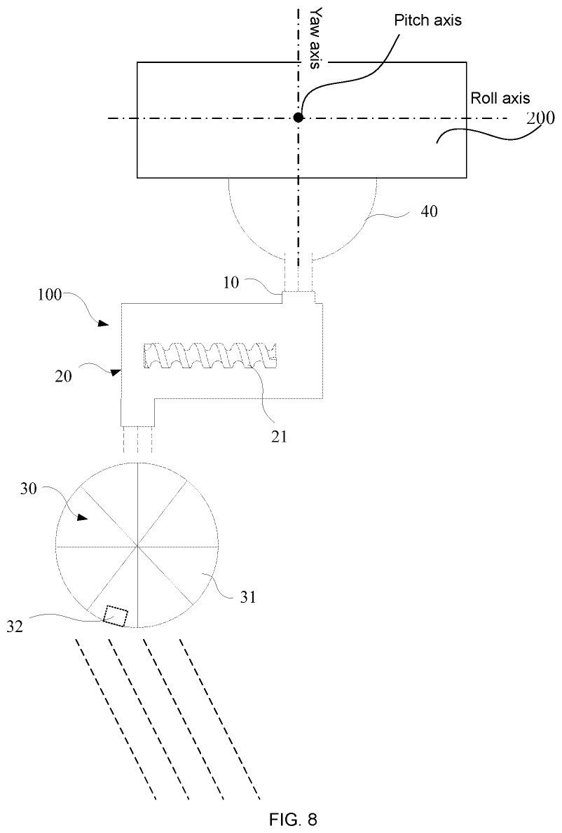

Referring to FIG. 8, when the spreading system 100 is connected to the frame 200 of the plant protection UAV 1000, the angle between a rotation plane of spinning disc 31 and the yaw axis of plant protection UAV 1000 may be greater than or equal to 0° and less than 90°.

Referring to FIG. 8, in some exemplary embodiments, the spreading system 100 may further include a spreading opening 32. The rotation plane of spinning disc 31 is not set horizontally. The spinning disc 31 may rotate at a high speed, driven by a spreading motor, for example, to generate a large centrifugal force to throw the material in the spinning disc 31 out from the spreading opening 32. For example, the material may be thrown out from the spreading opening 32 in a direction tangent to an outline of the spinning disc 31. Since spinning disc 31 is not set horizontally, when the material is thrown out, it has a vertical initial velocity, which improves the directional spreading ability of the material.

For example, the spreading opening 32 may be located at an edge of the spinning disc 31 or close to the edge.

For example, a radial edge of the spinning disc 31 may have an opening, which constitutes the spreading opening 32.

In some exemplary embodiments, the angle between the rotation plane of spinning disc 31 and the yaw axis of plant protection UAV 1000 is greater than or equal to 0° and less than 90°. The seeding opening 32 may face downward or obliquely downward from the plant protection UAV 1000. In this way, it can cause the material to be thrown out directly under or obliquely under the plant protection UAV 1000 by the centrifugal force, instead of being thrown out horizontally. The initial velocity in the vertical direction is quite large, and the motion trajectory is close to a straight line. Therefore, it can effectively improve the directional spreading performance of the spreading system 100, and has the advantages of high efficiency and convenience.

Understandably, in the case where the rotation speed of spinning disc 31 is high, when the spinning disc 31 rotates to a position where the spreading opening 32 is located obliquely or directly below the spinning disc 31, the material can be thrown out along an oblique tangent line, and the angle with the horizontal direction is small. In the case where the rotation speed of spinning disc 31 is low, when the spinning disc 31 rotates to a position where the spreading opening 32 is located obliquely or directly below the spinning disc 31, the material is thrown out, and the angle between the spinning disc 31 and the horizontal direction is relatively large. Therefore, the spreading width of the material can be controlled by controlling the rotation speed of the spinning disc 31. Moreover, it is understandable that when the rotation direction of spinning disc 31 is different, the direction in which the material is thrown is also different. For example, as shown in FIG. 8, when the spinning disc 31 rotates counterclockwise, the material is thrown out along the lower right side (the dotted line in FIG. 8 is the motion trajectory of the material when the material is thrown out). When the spinning disc 31 rotates clockwise, the material is thrown out along the lower left side. Therefore, the rotating speed and/or direction of the spinning disc 31 can be controlled by the spreading motor to achieve the purpose of directional spreading or quantitative spreading.

In some exemplary embodiments, in an installed state, the angle between the rotation plane of spinning disc 31 and the yaw axis of plant protection UAV 1000 may be less than or equal to 45 degrees. The angle between the rotation plane of spinning disc 31 and the yaw axis of plant protection UAV 1000 is small. This causes the material to be thrown out by the centrifugal force generated by the spinning disc 31 rotating at a high speed, and throwing direction of the material is as downward as possible; the vertical initial velocity is as large as possible and the horizontal initial velocity is as small as possible. It can be understood that under the premise that the spinning disc 31 rotates at the same speed, the smaller the angle between the rotation plane of spinning disc 31 and the yaw axis of plant protection UAV 1000, the greater the vertical initial velocity when the material is thrown out, and the stronger the directional spreading ability.

In some exemplary embodiments, the rotation plane of spinning disc 31 may be substantially parallel to the yaw axis of plant protection UAV 1000. It should be noted that the “substantially parallel” herein means that within the allowable range of installation or manufacturing errors, the angle between these two is within the range of from −5° to +5°. In this case, the rotation plane of spinning disc 31 is roughly parallel to the yaw axis of plant protection UAV 1000, and the spinning disc 31 is substantially arranged vertically. This allows the material to be thrown out from the spinning disc 31 substantially in a predetermined falling direction, making the spreading range the most controllable and the directional spreading ability the strongest.

In some exemplary embodiments, the rotation plane of spinning disc 31 may be substantially perpendicular to the yaw axis of plant protection UAV 1000.

The number of material spreading mechanisms 30 may be designed according to actual needs, such as one, two, three or more. Referring to FIG. 3, in some exemplary embodiments, the number of the material spreading mechanisms includes at least two, in order to effectively improve the spreading efficiency.

Referring to FIG. 4, when the spreading system 100 is connected to the frame 200 of the plant protection UAV 1000, the at least two material spreading mechanisms 30 may be arranged side by side or staggered in a direction parallel to the roll axis of the plant protection UAV 1000.

For example, the at least two material spreading mechanisms 30 may be arranged staggered in a direction parallel to the roll axis of the plant protection UAV 1000, which makes the rotation planes where the at least two material spreading mechanisms 30 are located intersect.

When the at least two material spreading mechanisms 30 are arranged side by side or staggered in a direction parallel to the roll axis, and the directions of the at least two material spreading mechanisms 30 are different, this allows the material to be spread in the front and rear directions of the frame 200 of the plant protection UAV 1000.

It can be understood that the number of material spreading mechanisms 30 includes at least two, and correspondingly, the number of spinning discs 31 includes at least two. In some exemplary embodiments, when the spreading system 100 is connected to the frame 200 of the plant protection UAV 1000, the at least two material spreading mechanisms 30 are arranged in a direction parallel to the roll axis of the plant protection UAV 1000. The angles between the rotation planes of at least two spinning discs 31 and the yaw axis of the plant protection UAV 1000 are substantially equal, and the inclination directions of the rotation planes of the at least two spinning discs 31 are opposite.

In the spreading system 100 described above, the at least two material spreading mechanisms 30 are arranged in a direction parallel to the roll axis of the plant protection UAV 1000. In addition, the inclination directions of the rotation planes of the at least two spinning discs 31 are opposite, and the inclination angles thereof are substantially the same. In this way, the material in the at least two spinning discs 31 may be symmetrically thrown out in the front and rear directions of the frame 200, thereby improving the spreading uniformity of the plant protection UAV 1000.

In some exemplary embodiments, when the spreading system 100 is connected to the frame 200 of the plant protection UAV 1000, the at least two material spreading mechanisms 30 are arranged side by side or staggered in a direction parallel to the pitch axis of the plant protection UAV 1000.

When the at least two material spreading mechanisms 30 are arranged side by side or staggered in the direction parallel to the pitch axis, and the directions of the two material spreading mechanisms 30 are different, the material can be spread in the left and right directions of the frame 200 of the plant protection UAV 1000.

In some exemplary embodiments, the material spreading mechanism 30 includes a spinning disc 31. When the spreading system 100 is connected to the frame 200 of the plant protection UAV 1000, the at least two material spreading mechanisms 30 are arranged in a direction parallel to the pitch axis of the plant protection UAV 1000. The angles between the rotation planes of the at least two spinning discs 31 and the yaw axis of the plant protection UAV 1000 are substantially equal, and the inclination directions of the rotation planes of at least two spinning discs 31 are opposite.

In the spreading system 100 described above, the at least two material spreading mechanisms 30 are arranged in a direction parallel to the pitch axis of the plant protection UAV 1000. Moreover, the inclination directions of the rotation planes of the at least two spinning discs 31 are opposite. In this way, the material in the at least two spinning discs 31 can be symmetrically thrown out in the left and right directions of the frame 200, thereby improving the spreading uniformity of the plant protection UAV 1000.

In some exemplary embodiments, the spreading system 100 may be mounted on the body 201 or the landing gear 202 of the frame 200. For example, the plant protection UAV 1000 may include two or more landing gears 202, and the spreading system 100 may be mounted on one or more of the landing gears 202.

For example, the at least one material conveying mechanism 20, the material spreading mechanism 30 or the material box 40 may be mounted on the body 201 or the landing gear 202 of the frame 200 so as to realize the assembly and fixation of the spreading system 100.

For example, the spreading system 100 also includes a material box 40. The material box 40 may be mounted on the frame 200 of the plant protection UAV 1000, thereby achieving a fixed connection between the spreading system 100 and the frame 200.

For example, the material box 40 may be mounted on the body 201 or the landing gear 202 of the frame 200. For example, the material box 40 may be engaged with the body 201 of the frame 200.

Referring to FIG. 1, in some exemplary embodiments, the material box 40 is located above the material conveying mechanism 20. This allows the material in the material box 40 to fall to the material conveying mechanism 20 through the material inlet 10 under the action of gravity.

Referring to FIG. 1, in some exemplary embodiments, the material spreading mechanism 30 may be located below the material conveying mechanism 20 so that the material delivered by the material conveying mechanism 20 may fall to the material spreading mechanism 30.

Referring to FIG. 1, in some exemplary embodiments, the material conveying mechanism 20 may be located between the material box 40 and the material spreading mechanism 30. In this way, the material in the material box 40 can be dropped to the material conveying mechanism 20 through the material inlet 10 under the action of gravity, and the material delivered by the material conveying mechanism 20 can be dropped to the material spreading mechanism 30.

Referring to FIGS. 1 and 2, the present disclosure also provides a plant protection UAV 1000 including a frame 200 and a seeding system 100. The spreading system 100 is mounted on the frame 200.

In some exemplary embodiments, in the plant protection UAV 1000, the screw mechanism 21 may transfer the material from the material inlet 10 to the material spreading mechanism 30 by way of rotating. Therefore, the motion information of the screw mechanism 21 may be controlled by the driving device 22. In this way, the feeding flow of the material can be accurately controlled, with a high controllable range and little influence from the shape of the material. In addition, it can realize continuous feeding, thereby realizing quantitative feeding to the material spreading mechanism 30 and improving the spreading uniformity of the plant protection UAV 1000.

For example, the spreading system 100 may include any of the spreading system 100 as described above. The plant protection UAV 1000 may include any of the plant protection UAV 1000 as described above.

In some exemplary embodiments, the plant protection UAV 1000 may be configured to adjust at least one of the motion states of the material spreading mechanism 30 and the driving parameters of the driving device 22, so as to adjust the amount of material spread from the spreading system 100, thereby achieving quantitative spreading.

For example, the motion state of the material spreading mechanism 30 includes the motion direction and/or motion speed of the material spreading mechanism 30. For example, the driving parameters of the driving device 22 include the rotation speed and/or the rotation direction of the driving device 22.

For example, the spreading motor may drive the spinning disc 31 to rotate. When the driving parameters of the driving device 22 are fixed, the motion state of the spinning disc 31 may be adjusted with the spreading motor. Hence, the amount of material spread from the spreading system 100 may be adjusted to achieve quantitative spreading.

For example, when the motion state of the material spreading mechanism 30 is fixed, the driving parameters of the driving device 22 may be adjusted to adjust the material spreading amount from the spreading system 100 so as to achieve quantitative spreading.

Of course, the driving parameters of the driving device 22 and the motion state of the material spreading mechanism 30 may also be adjusted at the same time to adjust the amount of material spread from the spreading system 100, so as to achieve quantitative spreading.

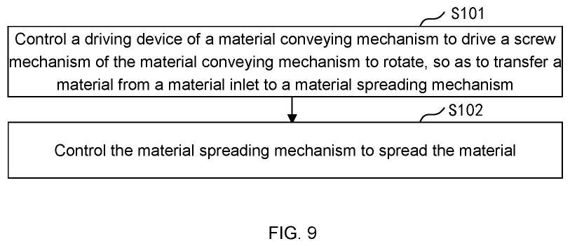

Referring to FIG. 9, FIG. 9 is a schematic flowchart of a spreading control method of a plant protection UAV 1000 provided by some exemplary embodiments of the present disclosure embodiment. This spreading control method may be applied to any plant protection UAV 1000 described above to implement spreading operations.

As shown in FIG. 9, the spreading control method for the plant protection UAV 1000 in the present disclosure may include step S101 and step S102.

Step S101, control a driving device 22 of a material conveying mechanism 20 to drive a screw mechanism 21 of the material conveying mechanism 20 to rotate, so as to transfer a material from a material inlet 10 to a material spreading mechanism 30.

Step S102, control the material spreading mechanism 30 to spread the material.

According to the spreading control method described above, the driving device 22 may be controlled to drive the screw mechanism 21 to rotate so as to quantitatively transfer the material from the material inlet 10 to the material spreading mechanism 30; in addition, by controlling the material spreading mechanism 30, the material at the material spreading mechanism 30 may be spread out. This enables precise control of the feeding flow of the material. It has a high controllable range, is less affected by the material form, and may realize continuous feeding or spreading. This enables quantitative feeding and/or directional spreading of the material to the material spreading mechanism 30, thereby improving the spreading uniformity of the plant protection UAV 1000.

In some exemplary embodiments, the controlling of the driving device 22 of the material conveying mechanism 20 to drive the screw mechanism 21 of the material conveying mechanism 20 to rotate includes: controlling the driving device 22 to drive the screw mechanism 21 to rotate with a preset driving parameter(s), where the driving parameter(s) includes a rotation speed and/or a rotation direction.

The preset driving parameter(s) herein may be set according to actual needs and is not limited herein.

In some exemplary embodiments, the screw mechanism 21 includes a first screw mechanism 211 and a second screw mechanism 212. The plant protection UAV 1000 is configured to control the driving device 22 to drive the first screw mechanism 211 to rotate in a first motion state to adjust the discharge volume of the first material outlet 51 of the material conveying mechanism 20, and drive the second screw mechanism 212 to rotate in a second motion state to adjust the discharge amount of the second material outlet 52 of the material conveying mechanism 20. The first motion state includes the rotation direction and/or rotation speed of the first screw mechanism 211; the second motion state includes the rotation direction and/or rotation speed of the second screw mechanism 212.

The first motion state and the second motion state may be the same or different.

In some exemplary embodiments, the spreading control method includes: controlling the driving device 22 to drive the first screw mechanism 211 to rotate in a first motion state to adjust the discharge amount of the first material outlet 51 of the material conveying mechanism 20, and drive the second screw mechanism 211 to rotate in a second motion state to adjust the discharge amount of the second material outlet 51 of the material conveying mechanism 20.

In some exemplary embodiments, the working parameter(s) of the power system 300 may also be adjusted in order to adjust the motion state of the frame 200, thereby achieving quantitative seeding of the plant protection UAV 1000. The operating parameter(s) of the power system 300 may include the rotation speed and/or rotation direction of the power system 300. The motion state of the frame 200 includes the motion direction and/or motion speed of the frame 200, such as flight speed.

In some exemplary embodiments, the spreading control method also includes: controlling the frame 200 of the plant protection UAV 1000 to move in a preset motion state, where the motion state includes the motion direction and/or the motion speed.

For example, the operating parameter(s) of the power system 300 may be controlled to control the motion of the frame 200 in a preset motion state. For example, the operating parameter(s) of the power system 300 may be controlled to control the frame 200 to fly at a preset flight speed.

In the description of the present disclosure, it should be noted that, unless otherwise explicitly described and limited, the terms “mounting”, “connecting” and “connection” should be understood in a broad sense. For example, it can be a fixed connection, a detachable connection, or an integral connection. The connection can be mechanical or electrical. It can be a direct connection or an indirect connection via an intermediary. It can be an internal communication between two elements or an interaction between two elements. For a person of ordinary skill in the art, the specific meanings of the above terms in the present disclosure can be understood according to specific circumstances.

In present disclosure, unless otherwise explicitly described and limited, the term that a first feature is “above” or “below” a second feature may include the case of direct contact between the first and second features, or may include the case where the first and second features are not in direct contact but are in contact via an additional feature therebetween. Furthermore, the term that a first feature is “on”, “above” and “over” a second feature includes the case where the first feature is directly above and obliquely above the second feature, or simply mean that the first feature is higher in level than the second feature. The term that a first feature is “beneath”, “below” and “under” a second feature includes the case where the first feature is directly below and obliquely below the second feature, or simply means that the first feature is lower than the second feature.

The above disclosure provides many different exemplary embodiments or examples for implementing different structures of the present disclosure. To simplify the present disclosure, the components and arrangements of specific examples are described above. Of course, they are merely examples and are not intended to limit the present disclosure. In addition, present disclosure may repeat reference numbers and/or reference letters in different instances; this repetition is for simplicity and clarity purposes only, and does not indicate a relationship between the various exemplary embodiments and/or arrangements discussed. In addition, the present disclosure provides examples of various specific processes and materials. However, a person of ordinary skill in the art may appreciate the application of other processes and/or the use of other materials.

In the present disclosure, for the description of certain terms “one embodiment”, “some embodiments”, “illustrative embodiments”, “examples”, “specific examples”, “some examples” and the like, they refer to that a specific method step, feature, structure, material or characteristic described in connection with an embodiment or example is included in at least one embodiment or example of the present disclosure. In the present disclosure, schematic representations of the above terms do not necessarily refer to the same embodiment or example. Furthermore, the specific method steps, features, structures, materials or characteristics described may be combined in any suitable manner in any one or more embodiments or examples.

The above are only some specific exemplary embodiments of present disclosure, and the scope of protection of the present disclosure is not limited thereto. A person skilled in the art may easily think of various equivalent modifications or substitutions within the technical scope disclosed in the present disclosure. These modifications or substitutions should be covered by the scope of protection of the present disclosure. Therefore, the scope of protection of the present disclosure should be determined based on the scope of protection of the claims.

What is claimed is:

1. A spreading system for an aerial vehicle, comprising:
at least one material inlet, configured to dock with a material box;
a material conveying mechanism, including at least one screw mechanism and at least one driving device in transmission connection with the at least one screw mechanism; and
at least one material spreading mechanism, configured to spread a material in the material box, wherein
the at least one driving device is configured to drive the at least one screw mechanism to rotate, so as to transfer the material from the at least one material inlet to the at least one material spreading mechanism in a rotating manner,
the at least one material spreading mechanism includes a spinning disc, and when the spinning disc rotates, the material in the spinning disc is thrown out along a periphery of the spinning disc, and
when the at least one material spreading mechanism is connected to a frame of the aerial vehicle, an angle between a rotation plane of the spinning disc and a yaw axis of the aerial vehicle is equal to 0°.

2. The spreading system according to claim 1, wherein the screw mechanism includes at least one of a worm or a spiral brush; or
the at least one screw mechanism includes at least two screw mechanisms, and the at least two screw mechanisms are arranged coaxially.

3. The spreading system according to claim 1, further comprising:
a first material outlet and a second material outlet configured to dock with the at least one material spreading mechanism, wherein
the at least one screw mechanism includes a first screw mechanism and a second screw mechanism,
the at least one material inlet includes a first material inlet and a second material inlet,
the first screw mechanism is configured to transfer the material from the first material inlet to the first material outlet, and
the second screw mechanism is configured to transfer the material from the second material inlet to the second material outlet.

4. The spreading system according to claim 3, wherein when the spreading system is connected to a frame of the aerial vehicle, projections of the first material inlet and the first material outlet on a plane perpendicular to a yaw axis of the aerial vehicle are arranged in sequence along a first direction, and projections of the second material inlet and the second material outlet on the plane perpendicular to the yaw axis of the aerial vehicle are arranged in sequence along a second direction, and the first direction is opposite to the second direction.

5. The spreading system according to claim 4, wherein a rotation direction of the first screw mechanism is opposite to a rotation direction of the second screw mechanism.

6. The spreading system according to claim 3, wherein when the spreading system is connected to a frame of the aerial vehicle, projections of the first material inlet and the first material outlet on a plane perpendicular to a yaw axis of the aerial vehicle are arranged in sequence along a first direction, and the second material inlet and the second material outlet are arranged in sequence along the first direction.

7. The spreading system according to claim 6, wherein a rotation direction of the first screw mechanism is the same as a rotation direction of the second screw mechanism.

8. The spreading system according to claim 3, wherein when the spreading system is connected to a frame of the aerial vehicle, the first material outlet and the second material outlet are arranged in a direction parallel to a roll axis of the aerial vehicle.

9. The spreading system according to claim 3, wherein when the spreading system is connected to a frame of the aerial vehicle, the first material outlet and the second material outlet are arranged in a direction parallel to a pitch axis of the aerial vehicle.

10. The spreading system according to claim 1, wherein the transmission connection between the at least one driving device and the at least one screw mechanism includes a direct transmission, or an indirect transmission.

11. The spreading system according to claim 1, wherein the at least one material spreading mechanism includes a disc spreading mechanism or an air pump spreading mechanism.

12. The spreading system according to claim 1, wherein the rotation plane of the spinning disc is substantially parallel to the yaw axis of the aerial vehicle.

13. The spreading system according to claim 1, wherein a rotation plane of the spinning disc is substantially perpendicular to a yaw axis of the aerial vehicle.

14. The spreading system according to claim 1, wherein the at least one material spreading mechanism includes at least two material spreading mechanisms, and when the spreading system is connected to a frame of the aerial vehicle, the at least two material spreading mechanisms are arranged side by side or staggered in a direction parallel to a roll axis of the aerial vehicle.

15. The spreading system according to claim 14, wherein the at least two material spreading mechanisms each includes a spinning disc, when the spreading system is connected to the frame of the aerial vehicle, the at least two material spreading mechanisms are arranged in a direction parallel to a roll axis of the aerial vehicle, angles between rotation planes of at least two spinning discs and a yaw axis of the aerial vehicle are substantially equal, and inclination directions of the rotation planes of the at least two spinning discs are opposite.

16. The spreading system according to claim 14, wherein when the spreading system is connected to the frame of the aerial vehicle, the at least two material spreading mechanisms are arranged side by side or staggered in a direction parallel to a pitch axis of the aerial vehicle.

17. The spreading system according to claim 16, wherein the at least two material spreading mechanisms each includes a spinning disc, when the spreading system is connected to the frame of the aerial vehicle, the at least two material spreading mechanisms are arranged in a direction parallel to a pitch axis of the aerial vehicle, angles between rotation planes of at least two spinning discs and a yaw axis of the aerial vehicle are substantially equal, and inclination directions of the rotation planes of the at least two spinning discs are opposite.

18. The spreading system according to claim 1, wherein the material conveying mechanism is arranged between the material box and the at least one material spreading mechanism.

19. A spreading system for an aerial vehicle, comprising:
at least one material inlet, configured to dock with a material box;
a material conveying mechanism, including at least one screw mechanism and at least one driving device in transmission connection with the at least one screw mechanism; and
at least one material spreading mechanism, configured to spread a material in the material box, wherein
the at least one driving device is configured to drive the at least one screw mechanism to rotate, so as to transfer the material from the at least one material inlet to the at least one material spreading mechanism in a rotating manner; and
the at least one screw mechanism includes a first screw mechanism and a second screw mechanism, and the first screw mechanism and the second screw mechanism are arranged non-coaxially and driven by the same driving device simultaneously.

20. The spreading system according to claim 19, wherein the at least one material spreading mechanism includes a spinning disc, and when the spinning disc rotates, the material in the spinning disc is thrown out along a periphery of the spinning disc; and when the at least one material spreading mechanism is connected to a frame of the aerial vehicle, an angle between a rotation plane of the spinning disc and a yaw axis of the aerial vehicle are greater or equal to 0° and less than 90°.
